(19) United States
(12) Patent Application Publication
(10) Pub. No.: US 2007/0033203 A1
(43) Pub. Date: Feb. 8, 2007

(54) System and method for locating a lost person

(76) Inventors: John E. Nemazi, Bloomfield Hills, MI (US); James W. Proscia, Dearborn, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/196,189

(22) Filed: Aug. 2, 2005

(51) Int. Cl. G06F 7/00

(52) U.S. Cl. 707/100

(57) ABSTRACT

A method for locating a lost person includes receiving from a posting party of search information that identifies a lost party. This search information is made accessible to an internet search engine. A searching user performs a search with a public message indicating that someone (i.e., the posting party) is looking for the lost party. A message from the searching user providing contact information regarding the lost party is received. The identity of the searching user is validated. Finally, the posting party is provided with the contact information.

### BACKGROUND OF THE INVENTION

1. Field of the Invention

The present invention relates to methods of finding people over the internet.

2. Background Art

The world wide nature of the Internet has allowed information to be searched with such breadth that previously could not have been imagined. On-line searching services such as those provided by Yahoo, Google, Ask Jeeves, and the like allow information to be obtained from millions of different sources and websites. Such information ranges from technical documents to cooking recipes. On-line shopping providers and auction services such as Ebay allow people to find virtually any desired new or used object. The success of these internet-based information locating service at least in part owe their success and utility to the large number of internet websites currently available, the ever increasing number of internet users, and the increasing speed with which information is shared over the internet.

A number of service providers provide internet based tools or services for locating a lost people. Typically, these lost person locators are electronic “White Pages” in which a large database of individual with related contact information such as telephone number and addresses are provided. In other person locator services, various public records are searched in order to find the missing person. Although use of these prior art people locator services has been extremely successful, each method of locating a person is subject to a number of problems that diminish their effectiveness. For example, if the person being sought has changed their name these prior art methods are likely to fail. If a person has an unlisted phone number, which is becoming increasingly common with the use of cell phones as one exclusive phone service, “White Page” searches are ineffective. If the person being sought has a common name, the prior art locators may provide too many hits to be useful Moreover, those methods searching public records depend on the accuracy and age of those records.

Accordingly, there exists a need for improved methods of specifically locating lost persons.

### SUMMARY OF THE INVENTION

The present invention solves one or more problems of the prior art by providing in at least one embodiment a method of locating a lost person. The method of this embodiment comprises providing search information that identifies a lost party to a search engine. This search information is obtained from a posting party that seeks to contact the lost party. The search engine is accessible to a plurality of searching users over a network of computers, and in particular over the Internet. The present embodiment advantageously takes advantage of the fact that internet users tend to search the names of individuals that they know and in particular, internet users tend to search for their own names over the internet to see what information about themselves is available. The present invention provides a searching user performing such search with a public message indicating that someone (i.e., the posting party) is looking for the lost party. A message from the searching user providing personal information regarding the lost party is received. The identity of the searching user is validated. Finally, at least one of the posting party or searching user is provided with contact information to enable direct communication between the posting party and the searching user.

### BRIEF DESCRIPTION OF THE DRAWINGS

FIG. 1 is a flowchart illustrating one embodiment of the lost party locating method of the invention;

FIG. 2 is a flowchart illustrating another embodiment of the lost party locating method of the invention;

FIG. 3 is a schematic illustrating the interactions between the posting party, searching user, lost party, and search service providers with the lost party database; and

FIGS. 4a and 4b is a flowchart illustrating a specific implementation of the method of the invention.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

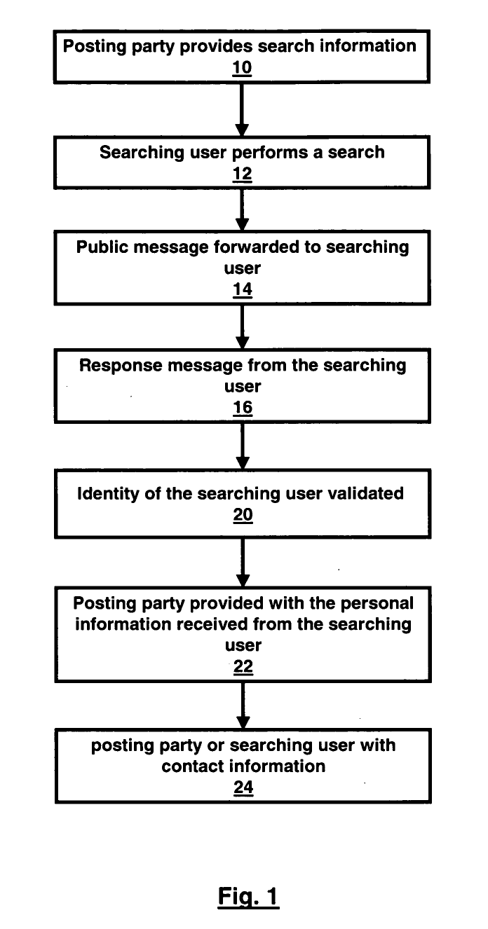

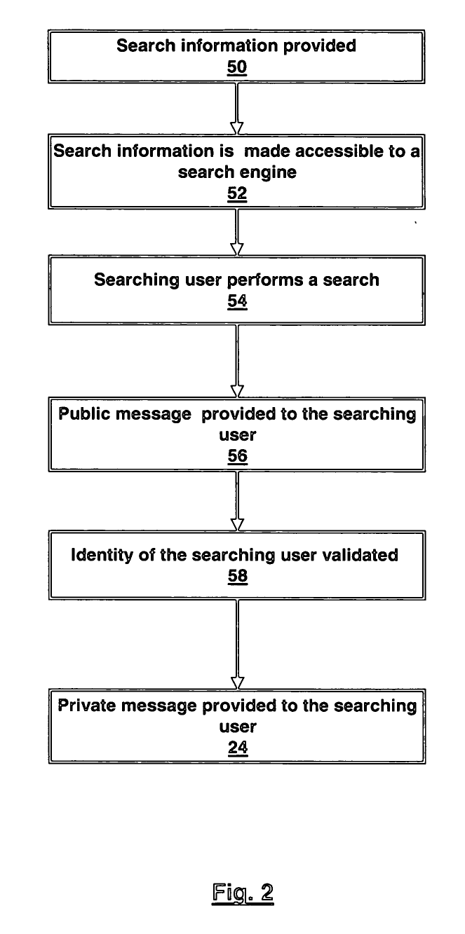

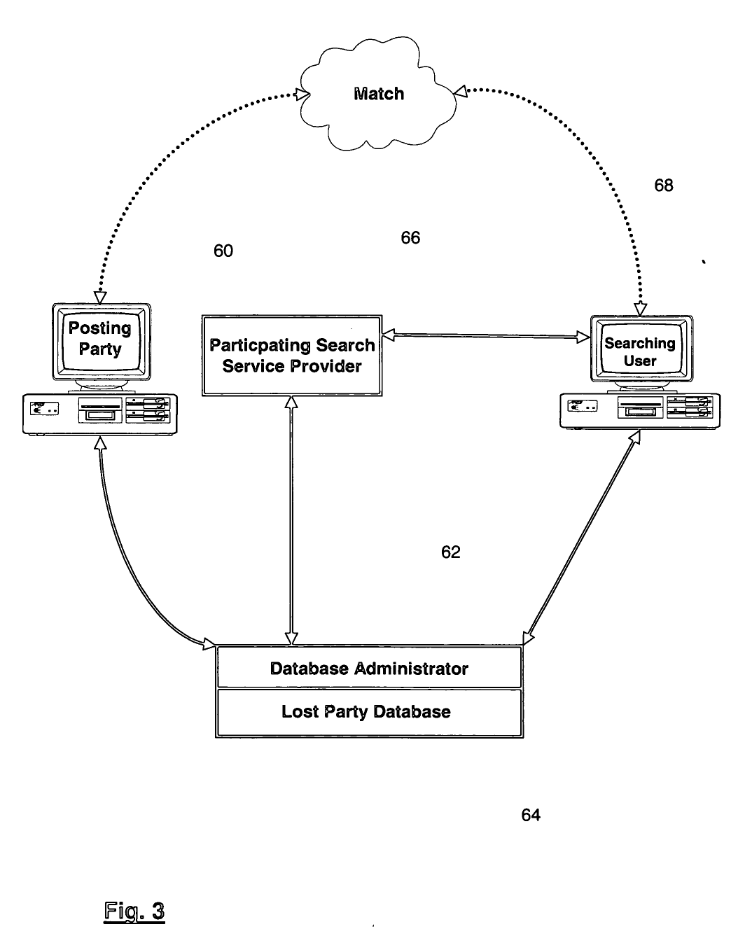

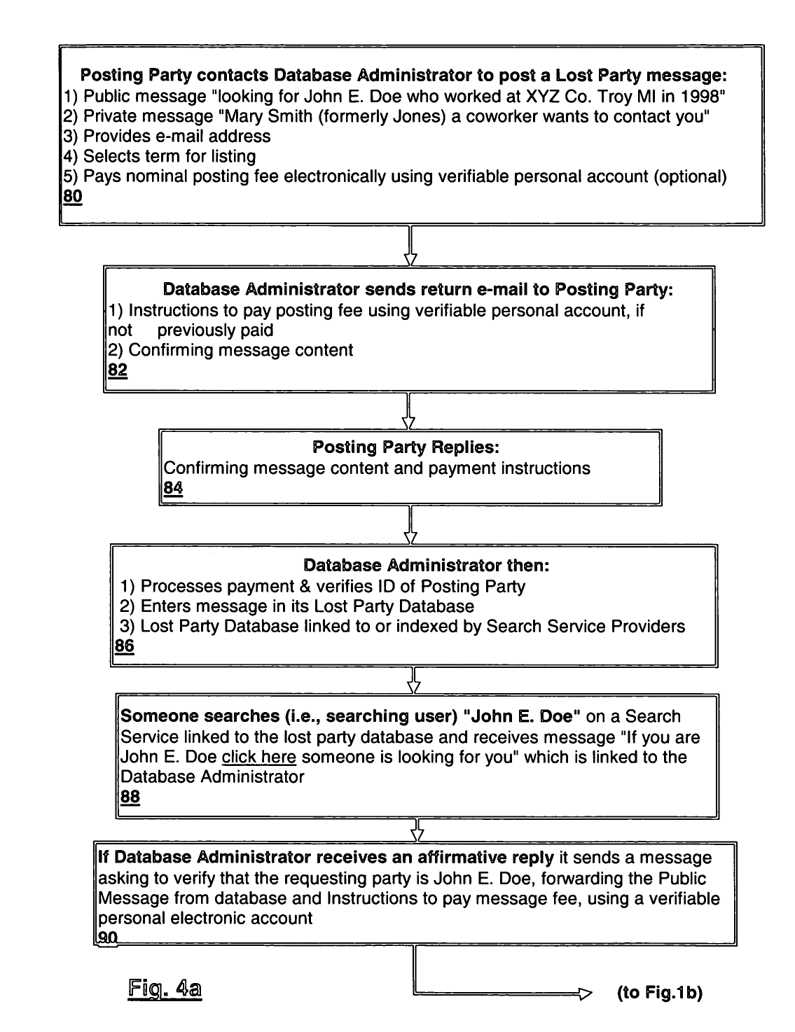

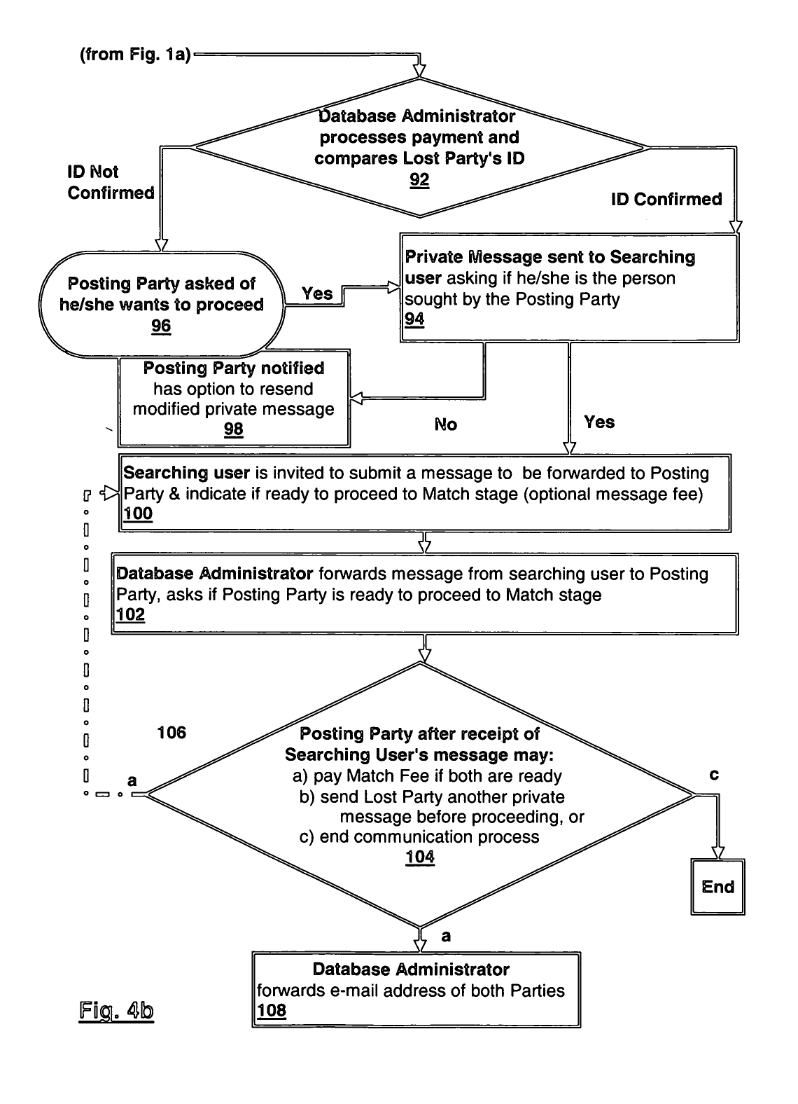

With reference to FIG. 1, a flowchart illustrating an embodiment of the invention is provided. As shown in step 10 search information is provided by a posting party that identifies a lost party to a search engine. Typically, the search information is provided over the Internet. Specifically, this search information is provided to an entity (“Participating Entity”) responsible for the implementation of one or more steps of the method. Such a Participating Entity may be an individual or an organization. Moreover, a given implementation of the present embodiment may involve several Participating Entities (e.g., a lost database administrator and several participating search service providers) Typically, this search information is received by a microprocessor-base system maintained by or accessible to the at least one Participating Entity. At least a portion of the search information is stored in a lost party database in any suitable digital form (e.g., on a hard disks, magnetic tape storage system, CDs, DVDs, optical drive, RAM, and the like). The posting party can be any individual or organization seeking to contact the lost party. In a variation of this embodiment, the posting party will pay a fee for inclusion of the search information in a form accessible by the search engines. Typically, the search information is accessible to the search engines for a finite period of time determined by the fee paid by the posting party. In another variation, a fee is only collected from the posting party if a match is made. In still another variation, the search information is included in a lost party database linked to one or more search engines which are accessible to a plurality of searching users over a network of computers, and in particular over the Internet. Examples of such search engines include, but are not limited to, the search engines used by Yahoo™, Google™, AskJeeves™, AltaVista™, MSN Search™, HotBot™, Lycos™, AltaVista™, AOL Search™, AllTheWeb™, Ask Jeeves™, and the like.

The present embodiment advantageously takes advantage of the fact that Internet users tend to search the names of individuals that they know and in particular, internet users tend to search for their own names over the internet to see what information about themselves is available. As indicated by step 12, a searching user performs such search while accessing the Internet. The searching user may accessible the Internet by any suitable means. For example, the searching user may access the Internet with a personal computer, a web enabled mobile phone, a terminal, a web enabled PDA, a web enabled television, and the like. Typically, but not necessarily, the searching party is the lost party. If the search criteria used by the searching user in step 12 is sufficiently similar to the posted lost party information to constitute a “hit” or match (i.e., the search criteria include the lost party's name, variations of the lost party's name, synonym of the lost party's name, common misspellings of the lost party's name, or derivative thereof), a public message indicating that someone (i.e., the posting party) is looking for the lost party is provided by at least one Participating Entity (step 14). The public message may be stored at the search service provider or provided via a link to the lost party database. Optionally, the public message may include a photograph (i.e., a digital image). For example, the photograph may be of the lost party or the posting party or of anything useful in identifying the lost party. The “hit” information can be transmitted to the lost party database which then sends the public message to the searching user while logging the event. Typically, the public message will include a least a portion of the search information provided in step 10. Such a public message is provided by a microprocessor based system maintained by at least one Participating Entity. A response message from the searching user providing personal information regarding the lost party is received by at least one Participating Entity if the searching party desires to provide such information (step 16). After reviewing the public message the identity of the searching user is validated by at least one Participating Entity (step 20). As part of the validation process, the posting party is optionally provided with at least a portion of the personal information received from the searching user by at least one Participating Entity (step 22). Finally, at least one of the posting party or searching user is provided by at least one Participating Entity with contact information to enable direct communication between the posting party and the searching user (step 24) if the validation process is sufficiently successful or if the Posting party so desires. Typically, this information is only provided when payment of a match fee has been confirmed. In a variation of this embodiment, one or more of the steps set forth above that are implemented by a Participating Entity are executing by microprocessor-based systems in communication with suitable digital storage media (e.g., on a hard disks, magnetic tape storage system, CDs, DVDs, optical drive, RAM, and the like) as needed. In another variation, each of the steps implemented by a Participating Entity are executed by a microprocessor based system in communication with suitable digital storage media maintained by a single Participating Entity.

In a variation of the invention, the information provided in step 10 is made available to the search engine by its inclusion on a web page with the web page being indexed such that it is accessible to the search engine. In another variation of the invention, the information provided in step 10 is included in an index utilized by the search engine without a web site also including the information. In this latter variation, the information is directly entered into the index utilized by the search engine. Similarly, in a variation of the invention, the public message provided in step 14 is provided to the searching user via a web page. The search information includes any information that is useful to identify the lost party including for example, the name of the lost party. Optionally, the search information further includes one or more identifying characteristics of the lost party. Such characteristics include, for example, the lost party's education history, the lost party's marital history, nicknames for the lost party, the lost party's relatives, the lost party's employment history, and combinations thereof.

As set forth above, a response message is received in step 16. This response information may be provided by any number of methods. For example, the response message may be provided by filling out a form on a web page, by email, by phoning a central processing location, by land mail, or the like. In a variation, when a form is used, the form includes one or more question related to characteristics selected from the group consisting of the lost party's education history, the lost party's marital history, nicknames for the lost party, the lost party's relatives, the lost party's employment history, and combinations thereof.

The identity of the searching user is optionally validated by the searching user successfully answering one or more questions further identifying the lost party. The identity of the searching user may also be validated by the searching user making a payment with a verifiable personal account. Such a verifiable personal account includes, for example, credit cards, debit cards, internet payment services such as PayPal, and the like.

Ultimately, the posting party is provided personal information in step 22 and optionally one or both of the posting party and searching user are provided with contact information in step 24. Again, any number of methods may be used to provide such information. For example, e-mail, a posting on a website, telephoning of the posting party, land-base mail, and the like may be used to provide the personal information or contact information.

With reference to FIG. 2, a flowchart illustrating another embodiment of the invention is provided. Search information that identifies a lost party is provided by a posting party in step 50 to at least one Participating Entity. The search information is the same as the search information set forth above. However, the search information of this embodiment also includes a public message and an optional private message. This information is then made accessible to a search engine (step 52). Again, the posting party may optionally pay a fee for inclusion of the search information in a form accessible by the search engine as set forth above. As indicated by step 54, a searching user performs an internet-based search. In response to the searching user's search the public message is provided to the searching user by at least one Participating Entity (step 56). The public message provides in one variation that the lost party is being sought when the searching user utilizing the search engine performs a search sufficient to return the information provided in step 50. The identity of the searching user is validated by at least one Participating Entity in step 58 in the same manner as set forth above. Upon a successful validation of the identity of the searching user, the private message is provided in step 60 to the searching user by at least one Participating Entity. In a variation of this embodiment, one or more of the steps set forth above that are implemented by a Participating Entity are executing by microprocessor-based systems in communication with suitable digital storage media (e.g., on a hard disks, magnetic tape storage system, CDs, DVDs, optical drive, RAM, and the like) as needed. In another variation, each of the steps implemented by a Participating Entity are executed by a microprocessor based system in communication with suitable digital storage media maintained by a single Participating Entity.

Alternatively, only the search criteria is provided to the Internet-based search services. Once a search hit occurs the information is automatically transmitted to the lost party database who directly responds to the searching user. Prior to transmitting the public message the searching user's email address can be screened and logged into order to avoid improper searches and SPAM attacks. Storing the private and preferable public messages only on the lost party database reduces the number of sites containing highly confidential information and in turn reduces the risk of unauthorized access by hackers.

In a variation of this embodiment, a message is forwarded from the lost party to the posting party. Specifically, contact information is forwarded from the searching user to the posting party. Such contact information may be provided by any method reasonably fashioned to reach the posting party. Such methods include, but at not limited to, email, land-base mail, instant messaging (“IM”), a posting on a website, and the like. Typically, if the information is posted on a website, the website is private requiring a successful logon by the posting party for the contact information to be accessed.

As set forth above, the search information provided in step 50 is made available to the search engine by its inclusion on a web page with the web page being indexed such that it is accessible to the search engine. In another variation of the invention, the information provided in step 50 is included in an index utilized by the search engine without a web site also including the information. In this latter variation, the information is directly entered into the index utilized by the search engine. Similarly, in a variation of the invention, the public message provided in step 56 is provided to the searching uses a web page. The search information includes any information that is useful to identify the lost party including for example, the name of the lost party. Optionally, the search information further includes one or more identifying characteristics of the lost party. Such characteristics include, for example, the lost party's education history, the lost party's marital history, nicknames for the lost party, the lost party's relatives, geographic information, the lost party's employment history, and combinations thereof.

The mechanism for validated the identity of the searching user in step 58 is the same as those set forth above. For example, the identity of the searching user is validated by the searching user successfully answering one or more questions that further identify the lost party. In another variation, personal information derived from the searching party is forwarded to the posting party. In still other variations, the identity of the searching user may also be validated by the searching user making a payment with a verifiable personal account. Such a verifiable personal account includes, for example, credit cards, debit cards, internet payment services such as PayPal, and the like. This same mechanism can be used to verify the identity of the posting party in order to deter misuse of the system by persons assuming a false identity.

With reference to FIG. 3, a schematic illustrating the interactions between the posting party, searching user, lost party, and search service providers (e.g. internet search providers) with the lost party database is provided. Posting party 60 provide database administrator 62 with search information that is useful in identifying a lost person (a person the posting party desires to contact). Database administrator 62 incorporates the search information into lost party database 64. The lost party database is preferably linked to a plurality of search engines maintained by search service provider 66. In a variation, the functions of database administrator 62 is absorbed by search service provider 66. Searching user 68 performs an Internet search via search service provider 66 as set forth above. A public message is provided to searching user 68 that the lost party is being sought when the searching user utilizing the search engine performs a search sufficient to return the search information. A response message is received from searching user 68 providing personal information regarding the lost party. Posting party 60 is provided the personal information received from the searching user. If the personal information is sufficient, a match is made with either posting party 60 or searching user 66 being provided with contact information to enable direct communication between posting party 60 and searching user 68.

With reference to FIG. 4, a flowchart illustrating a specific implementation of the method of the invention is provided. In step 80, a posting party provides lost party information to the lost party database administrator. This lost party information includes a public message and a private message. The public message includes an indication that the posting party is “looking for John E. Doe who worked at XYZ Co. Troy Michigan plant in 1998.” The lost party information also includes an optional private message “Mary Smith (formerly Jones) your old coworker wants to contact you.” In additional to this lost party information, contact information (e.g. an email address) for the posting party is also provided by the posting party. The posting party also selects any additional terms regarding the posting. Such additional terms may include, for example, the length of time the posting should last. Optionally, the posting user pays a nominal fee using a verifiable personal account. Such a verifiable personal account includes, for example, credit cards, debit cards, internet payment services such as PayPal, and the like. Such verifiable personal accounts are useful in validating the identity of the posting party thereby minimizing the potential of the posting party using the method of the invention for some nefarious purpose. In step 82, the lost party system sends an indication to the posting party verifying the content of step 80. In this step additional information may be provided to or solicited from the posting party. Such information may be instructions for paying a posting fee using a verifiable personal account if the fee has not been paid. The posting party replies to the message in step 84 thereby confirming message content and payment instructions if solicited.

Posting users may directly contact the lost party system at step 10 or alternatively, the posting party may be directed to the lost party system via a link from an affiliate web site. In the case of a referral from an affiliate's web site an affiliate ID code will be transmitted automatically by the posing user via a “cookie” stored on the posting user's computer at the time of accessing a lost party system advertisement on the affiliate's site. When the posting user contacts the lost party system the “cookie” will be transmitted and logged with a created file.

In step 86, the lost party system processes the payment and verifies the identification and email address of the posting party. At this point, the search service provider may apply various screening techniques to block certain types of persons, organizations, or web addresses from utilizing the searching method of the invention. For example, various criminal databases can be accessed to minimize the utilization of the invention for criminal purposes. If the processing is successful, the search information is included into a lost party database or placed in a form accessible by an internet search engine. If a distinct lost party database is used, this database is optionally linked to other search service provider's search engines or search databases. A public message including at least at portion of this search information is included in this step.

When by happenstance, someone (i.e., the searching user) searches for “John E. Doe” on a website providing access to the lost party database or on a website providing access to a search engine that has access to at least a portion of the search information, a “hit” occurs and a public message is provided (step 88). An example of such a message is: “If you are John E. Doe click here someone is looking for you.” If an affirmative reply is provided in step 88, the searching user is asked to identify his identity and relationship to “John E. Doe.” Verification of the searching users identity is accomplished in the manner set forth above and in particular by using a verifiable personal electronic account to pay a fee. For example, the searching party is asked to verify that they are “John E. Doe” (step 90). In addition, the public message is provided to the searching user.

The lost party system in step 92 attempts to verify the searching users identity with the information provided in step 90. If the verification process succeeds, the searching party is asked if they are the lost party or if they have information regarding the lost party (step 94). Optionally, if the searching party is not the lost party, the posting party is provided the option of not having the private message provided to the searching user. If the searching party is the lost party, the private message is provided to the searching party. If verification cannot be accomplished, the posting party is asked if they desire to proceed anyway (step 96).

If the searching user is not the lost party, the posting party is notified in step 98 and given to option to send a modified private message. If the identity of the lost party is successfully verified in step 94, the searching party is invited in step 100 to submit a response message to be forwarded to the posting party and to indicate if they are ready to proceed to the match stage. The message of step 100 is forwarded to the posting party and the posting party is asked if they are ready to proceed to the match stage. If both parties are ready to proceed, the match stage is executed in step 102. At this stage, an optional match fee may be paid by one or both of the searching party or the posting party (104). A second private message may also be sent from the posting party to the lost party. Similarly, a series of messages between the lost party and posting party may be solicited and forwarded as indicated by loop 106. Finally, contact information between the parties is exchanged in step 108.

When a searching party is directed to the lost party system via a search service provider a search source ID is transmitted to the lost party system and logged in the lost party file. The lost party system tracks fees received attributable to the referring affiliate for the posting user and the search service provider responsible for linking the searching party to the system.

The lost party database administrator may automatically or periodically provide a hit report to the posting party of “hits” resulting in the transmission of public messages to posting parties. These reports can if desired by the lost party database administrator include internet address information of the searching user. The lost party database administrator will also log all financial payments along with information identifying the search service provider which caused the original “hit”, and the source of the posting party listing. Referrals from advertisers can be managed using a system of advertiser “cookies” to identify where a posting party learned of the lost party database. In a variation of the invention, a participating internet search provider is provided with a revenue report and a payment related to revenue derived users originating from a Internet service provider. The lost party database administrator can periodically provide “hit” reports to the participating internet search providers and share a portion of the revenue received attributable to advertiser referrals and internet search providers in the period.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of locating a person, the method comprising:
a) providing search information in a form accessible to a search engine identifying a lost party, the search information being obtained from a posting party seeking to contact the lost party wherein the search engine is accessible to a plurality of searching users over a network of computers;
b) providing a public message to a searching user that the lost party is being sought when the searching user utilizing the search engine performs a search sufficient to return the information provided in step a;
c) receiving a response message from the searching user providing personal information regarding the lost party;
d) validating the identity of the searching user; and
e) providing at least one of the posting party or searching user with contact information to enable direct communication between the posting party and the searching user.

2. The method of claim 1 further comprising providing the posting party with at least a portion of the personal information received from the searching user.

3. The method of claim 1 wherein the search information provided in step a) is included on a web page with the web page being indexed such that it is accessible to the search engine.

4. The method of claim 1 wherein the search information provided in step a) is included in an index utilized by the search engine, the search information being available on a publically searchable website.

5. The method of claim 1 wherein the response message is provided by the searching user by filling out a form on a web page.

6. The method of claim 5 wherein the form includes one or more question related to characteristics selected from the group consisting of the lost party's education history, the lost party's marital history, nicknames for the lost party, the lost party's relatives, the lost party's employment history, lost party geographical data, and combinations thereof.

7. The method of claim 1 wherein the identity of the searching user is validated by the searching user successfully answering one or more questions further identifying the lost party.

8. The method of claim 1 wherein the identity of the searching user is validated by the searching user making a payment with a credit card, debit card, or online payment account.

9. The method of claim 1 wherein the posting party is provided the contact information via e-mail.

10. The method of claim 9 wherein the search information is accessible to the search engine for a finite period of time determined by the fee paid by the posting party.

11. The method of claim 9 wherein the search information further includes one or more characteristics selected from the group consisting of the lost party's education history, the lost party's marital history, nicknames for the lost party, the lost party's relatives, the lost party's employment history, lost party geographical information, and combinations thereof.

12. A microprocessor-based system executing the method of claim 1.

13. A method of locating person, the method comprising:
a) providing search information in a form accessible to a search engine identifying a lost party, the search information being obtained from a posting party seeking to contact the lost party wherein the search engine is accessible to a plurality of searching users over a network of computers, wherein the search information includes a public message and a private message;
b) providing the public message to a searching user that the lost party is being sought when the searching user utilizing the search engine performs a search sufficient to return the information provided in step a;
c) validating the identity of the searching user; and
d) providing the private message to the searching user.

14. The method of claim 13 wherein one of the posting party and the searching user pays a fee if a match is made.

15. The method of claim 14 further comprising providing contact information to one of the searching user and the posting party one payment of the match fee is confirmed.

16. The method of claim 13 wherein the information provided in step a is included on a web page with the web page being indexed such that it is accessible to the search engine.

17. The method of claim 13 wherein the information provided in step a is included in an index utilized by the search engine without a web site also including the information.

18. The method of claim 13 wherein the identity of the searching user is validated by the searching user successfully answering one or more questions further identify the lost party.

19. The method of claim 13 wherein the identity of the searching user is validated by the searching user making a payment with a credit or debit card account.

20. The method of claim 13 wherein the search information is accessible to the search engine for a finite period of time determined by a fee paid by the posting party.

21. The method of claim 13 further comprising periodically providing the posting user with a hit report.

22. The method of claim 13 further comprising providing a participating internet search provider with a revenue report and a payment related to revenue derived users originating from a Internet service provider.

23. The method of claim 13 further comprising logging searching user hits and screening for unauthorized users, and potential fraud prior to providing the public message.

24. A microprocessor-based system executing the method of claim 13.
